(19) United States
(12) Patent Application Publication
(10) Pub. No.: US 2008/0123043 A1
(43) Pub. Date: May 29, 2008

(54) LIQUID CRYSTAL DISPLAY PANEL

(75) Inventors: De-Jiun Li, Taipei County (TW); Kuo-Ching Chou, Taipei County (TW); Szu-Yu Fang, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., Taipei (TW)

(21) Appl. No.: 11/563,038

(22) Filed: Nov. 24, 2006

(51) Int. Cl. G02F 1/1339

(52) U.S. Cl. 349/156

(57) ABSTRACT

An LCD panel includes a first substrate, at least a supporting pad, a second substrate, at least a spacer and a liquid crystal layer. The supporting pad is disposed on the first substrate. The second substrate is disposed opposite to the first substrate. The spacers are disposed on the second substrate. The liquid crystal layer is disposed between the first substrate and the second substrate. The top facet of the spacer contacts with the top facet of the supporting pad and the top facet area of the supporting pad is smaller than the top facet area of the spacer. The LCD panel is able to stand a larger finger pressure, so as to prevent the liquid crystal layer from producing bubbles and mura defect.

### BACKGROUND OF THE INVENTION

1. Field of Invention

The present invention relates to a display panel, and particularly to a liquid crystal display panel (LCD panel).

2. Description of the Related Art

The rapid advancement in multimedia community benefits from the leaping progress in semiconductor component and display device. For display device, the liquid crystal display (LCD) with superior characteristics, such as high display quality, better efficiency for space usage, low power consumption, and no radiation, has become the main stream in the market. In general, an LCD includes an LCD panel and a backlight module for providing a planar light source, wherein the LCD panel is comprised of a color filter substrate, a thin film transistor array substrate (TFT array substrate) and a liquid crystal layer between the two substrates. Note that a conventional LCD panel process, termed as ‘one drop fill (ODF)’, is mainly to spread liquid crystal on the surface of the color filter substrate or the TFT array substrate in the LCD panel, followed by pressure-sticking the two substrates, so as to dispose the liquid crystal therebetween.

FIG. 1 is a schematic cross-sectional drawing of a conventional LCD panel. Referring to FIG. 1, an LCD panel 100 fabricated by the above-mentioned ODF process mainly includes a color filter substrate 110, a plurality of spacers 120, a TFT array substrate 130, a liquid crystal layer 140 and a sealant 150. The spacers 120 are disposed on the color filter substrate 110 and the spacers 120 contact the surface of the TFT array substrate 130. By disposing the spacers 120, a constant cell gap between the two substrates is maintained. The sealant 150 is disposed between the color filter substrate 110 and the TFT array substrate 130 and located at the peripheral strip-areas of the two substrates. The sealant 150 is ultraviolet-irradiated or heated and then pressed for curing, so as to combine the two substrates and keep the liquid crystal layer 140 among the two substrates 110 and 130 and the spacers 120.

During the ODF process, the support capability of the spacers 120 seriously affects the filling results of liquid crystal. In other words, for enabling the LCD panel 100 to bear larger finger pressure and vibration, the number of the spacers 120 in unit area is increased to enhance the support capability. However, in such a method, the top and bottom substrates could not be appropriately squeezed due to the excessive rigidity of the spacers 120 during the assembly process. Consequently, unwanted phenomena, such as liquid crystal vertical flow phenomenon or bubbles in the liquid crystal, would be occurred to reduce the ODF process yield.

For solving the above-described problem, another LCD panel is provided. FIG. 2 is a schematic cross-sectional drawing of another conventional LCD panel. Referring to FIG. 2, the LCD panel 200 at least includes a color filter substrate 210, a TFT array substrate 220 and a liquid crystal layer 240 between the two substrates 210 and 220. On the TFT array substrate 220, different areas have different heights. A common electrode 212 is disposed on the color filter substrate 210 and a plurality of spacers 230a, 230b with a same height is disposed on the common electrode 212.

Particularly, spacers 230a is contacted with the higher position of the TFT array substrate 220 for maintaining a desired constant cell gap between the two substrates 210 and 220. And, spacers 230b isn't contacted with the higher position of the TFT array substrate 220 ordinarily. While an external force is applied to the LCD panel 200, the gap, between two substrates 210 and 220, becomes smaller so as to make spacer 230b contact with the TFT array substrate 220 for sharing some loading force. In this way, the scheme not only can enable the LCD panel 200 to bear larger finger pressure, but also can allow an increased tolerance with the ODF process, which contributes to reduce the bubble defects or the mura defect (wide-area pixel optical defect) in the liquid crystal layer.

However, the above-described scheme needs to fabricate a plurality of spacers 230a and 230b; moreover, it is complex to define the appropriate positions of the spacers 230a and 230b. Besides, the compressive strengths of spacers 230a and 230b are limited. In particular, the finger pressure on the spacers 230a and 230b is hard to be evenly distributed, which may damage parts of common electrode 212 under the spacers 230a and 230b.

### SUMMARY OF THE INVENTION

Based on the above described, an object of the present invention is to provide an LCD panel with good capability for bearing finger pressure.

To achieve the above-described or other objects, the present invention provides an LCD panel, which includes a first substrate, at least a supporting pad, a second substrate, at least a spacer and a liquid crystal layer. The supporting pad is disposed on the first substrate, the second substrate is disposed opposite to the first substrate, the spacer is disposed on the second substrate and the liquid crystal layer is disposed between the first substrate and the second substrate. The top facet of the spacer contacts with the top facet of the supporting pad, while the top facet area of the supporting pad is smaller than the top facet area of the spacer.

In an embodiment of the present invention, the above-described top facet diameter of the supporting pad is ranged from 4 to 40 μm.

In an embodiment of the present invention, the above-described top facet diameter of the spacer is ranged from 10 to 46 μm.

In an embodiment of the present invention, the shape of the above-described supporting pad includes at least one of square-section column shape, rectangular-section column shape, cylinder shape, ellipse-section column shape, regular polygon-section column shape and irregular polygon-section column shape.

In an embodiment of the present invention, the shape of the above-described spacer includes at least one of square-section column shape, rectangular-section column shape, cylinder shape, ellipse-section column shape, regular polygon-section column shape and irregular polygon-section column shape.

In an embodiment of the present invention, the bottom area of the above-described spacer is larger than the top facet area thereof.

In an embodiment of the present invention, the hardness of the above-described supporting pad is higher than the hardness of the spacer.

In an embodiment of the present invention, the material of the above-described spacer includes an elastic material, for example, resin.

In an embodiment of the present invention, the above-described supporting pad is formed by stacking a plurality of film layers on the first substrate, and the material of the film layers is, for example, metal, dielectric material or organic material.

In an embodiment of the present invention, the above-described first substrate is, for example, a TFT array substrate, which includes a plurality of scan lines, a plurality of data lines, a plurality of TFTs and a plurality of pixel regions. The TFTs are driven by the scan lines and the data lines, while the pixel regions are electrically connected to the TFTs.

In an embodiment of the present invention, each of the scan lines and each of the data lines are cross-overlapped to form the supporting pad.

In an embodiment of the present invention, the above-described second substrate includes a color filter substrate.

Since the present invention adopts a design to make the spacer contact with the top facet of the supporting pad and to specify the top facet area of the supporting pad smaller than the top facet area of the spacer, thus the supporting pad is able to press into the spacer. Therefore, the LCD panel can bear larger finger pressure. In addition, during assembling the LCD panel of the present invention, it is able to reduce the bubble defect or the mura defect in the liquid crystal layer and to avoid the assembly deviations. Moreover, since the bottom area of the spacer is larger than the top facet area thereof, the press force can be effectively dispersed in order to prevent the spacer from crashing the common electrode therebelow. One more advantage with the present invention is that the supporting pad herein is formed without an extra process, which is certainly to reduce the production cost of the LCD panel.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic cross-sectional drawing of a conventional LCD panel.

FIG. 2 is a schematic cross-sectional drawing of another conventional LCD panel.

FIG. 3 is a schematic tri-dimensional side view of an LCD panel provided by an embodiment of the present invention.

FIG. 4 is a diagram showing the spacer in FIG. 3 in contact with the supporting pad.

FIG. 5 is a diagram showing the supporting pad presses into the spacer.

FIG. 6 is a schematic tri-dimensional side view of an LCD panel provided by another embodiment of the present invention.

### DESCRIPTION OF THE EMBODIMENTS

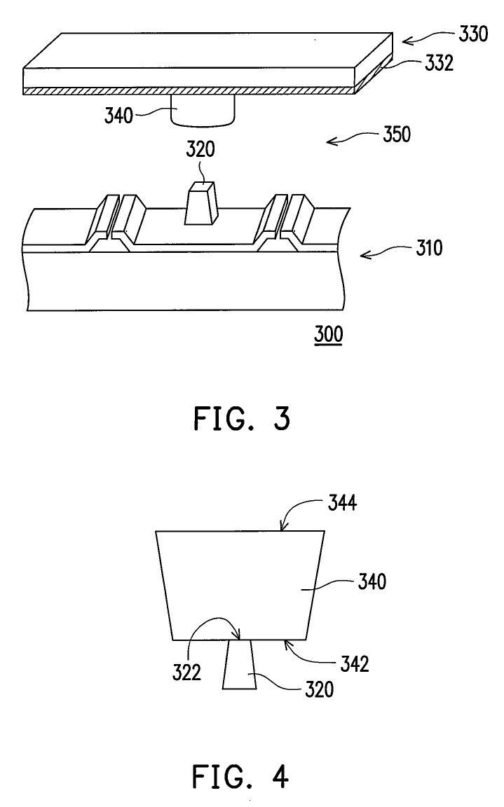

FIG. 3 is a schematic tri-dimensional side view of an LCD panel provided by an embodiment of the present invention. FIG. 4 is a diagram showing the spacer in FIG. 3 in contact with the supporting pad. Referring to FIGS. 3 and 4, an LCD panel 300 of the present invention includes a first substrate 310, at least a supporting pad 320, a second substrate 330, at least a spacer 340 and a liquid crystal layer 350. The supporting pad 320 is disposed on the first substrate 310. The second substrate 330 is disposed opposite to the first substrate 310. The spacer 340 is disposed on the second substrate 330. The liquid crystal layer 350 is disposed between the first substrate 310 and the second substrate 330. The top facet 342 of the spacer 340 contacts with the top facet 322 of the supporting pad 320, while the area of the top facet 322 of the supporting pad 320 is smaller than the area of the top facet 342 of the spacer 340.

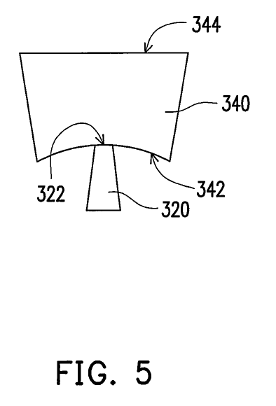

Referring to FIG. 4 again, since the area of the top facet 342 of the spacer 340 is much larger than the top facet 322 of the supporting pad 320 in the above-described LCD panel 300, according to an equation, support pressure (P)=support force (F)/contact area (A), the support pressure (P) of the spacer 340 is increased by decreasing the contact area (A). Therefore, with a minor applied force, the supporting pad 320 is able to press into the spacer 340, which makes the spacer 340 and the supporting pad 320 embedded with each other well and stably support the first substrate 310 and the second substrate 330 as well. In particular, in an embodiment of the present invention, the hardness of the supporting pad 320 allows to be higher than the hardness of the spacer 340, which further firmly combine the supporting pad 320 and the spacer 340 together, as shown in FIG. 5.

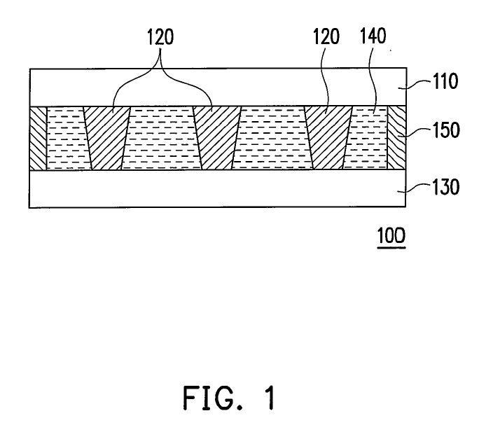

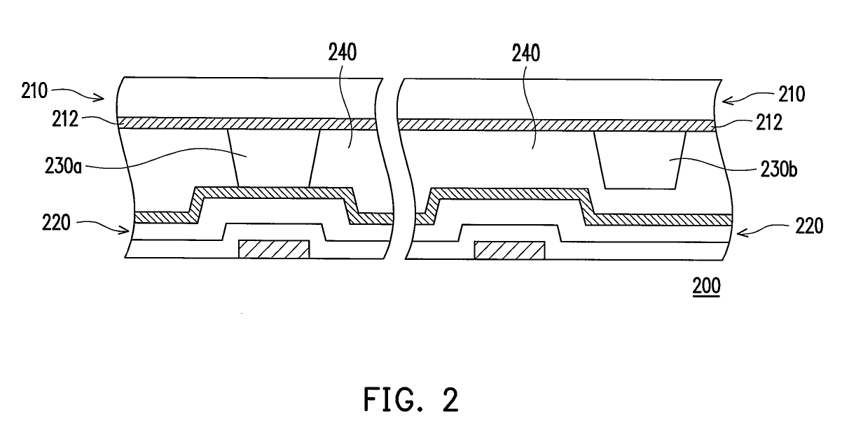

Accordingly, by adopting the supporting pad 320 and the spacer 340 in the present invention, the LCD panel 300 is capable of bearing a higher finger pressure. Furthermore, during an ODF process, the above-described design effectively can prevent the mura defect or bubble defect caused by an excessive rigidity of the spacer 120 occurred in a conventional LCD panel (as shown in FIG. 1), and the top and bottom substrates 330 and 310 can be appropriately squeezed as wished. Therefore, the LCD panel 300 of the present invention is able to enhance the margin of the ODF process and to bear a larger finger pressure.

To ensure no assembly deviation problem occurs during assembling the first substrate 310 and the second substrate 330, the diameter of the top facet 342 of the spacer 340 must be larger than the diameter of the top facet 322 of the supporting pad 320 by at least 6 μm. In an embodiment, the diameter of the top facet 342 of the spacer 340 is ranged from 10 to 46 μm, while the diameter of the top facet 322 of the supporting pad 320 is ranged from 4 to 40 μm. In this way, the assembly deviation problem can be effectively prevented and the spacer 340 is able to firmly contact the supporting pad 320.

Continuing referring to FIGS. 3 and 4, in an embodiment of the present invention, the shape of the spacer 340 includes, but not limited to by the present invention, at least one of square-section column shape, rectangular-section column shape, cylinder shape, ellipse-section column shape, regular polygon-section column shape and irregular polygon-section column shape. The material of the spacer 340 includes an elastic material, for example, resin. In addition, since the area of the bottom 344 of the spacer 340 is larger than the area of the top facet 342 of the spacer 340, the pressure force that the spacer 340 bears can be dispersed so as to prevent the common electrode 332 from being crushed by the spacer 340, as shown in FIG. 3.

The shape of the supporting pad 320 can be, for example, but not limited to by the present invention, at least one of square-section column shape, rectangular-section column shape, cylinder shape, ellipse-section column shape, regular polygon-section column shape and irregular polygon-section column shape. Note that the supporting pad 320 is formed, for example, by stacking a plurality of film layers (not shown) on the first substrate 310, and the material of the film layers can be, for example, metal, dielectric material or organic material.

In more detail, the film layers to form the supporting pads 320 are the film layers to form all the components on the first substrate 310. The first substrate 310 can be a TFT array substrate (Thin Film Transistor array substrate), which includes a plurality of scan lines (not shown), a plurality of data lines (not shown), a plurality of TFTs (not shown) and a plurality of pixel regions (not shown). The TFTs are driven by the scan lines and the data lines. The pixel regions are electrically connected to the TFTs and get displayed by switching the TFTs. In fact, the film layers to form the supporting pads 320 are the film layers to form the above-described scan lines, data lines, TFTs and the pixel regions. That is, the supporting pads 320 are fabricated by stacking the film layers originally to form the above-described components at different areas on the first substrate 310 corresponding to the spacers 340.

Usually, there are a first metal layer (a film layer to form the scan lines and the gates of the TFTs), a second metal layer (a film layer to form the data lines and the sources and drains of the TFTs), an insulation layer (located between the first metal layer and the second metal layer), a semiconductor layer (a film layer to form channel layers of the TFTs) and an organic layer (for example, an alignment film) disposed on a TFT array substrate. So, when forming devices (such as TFTs) on the TFT array substrate 310 (the first substrate 310), the supporting pads 320 can be formed on the first substrate 310 with stacking above layers in the same time. And, the position of the supporting pads 320 is corresponding to the spacers 340. In detail, the processes of forming components on the TFT array substrate are utilized to make some specific film layers be stacked on each other, and the supporting pads 320 are spontaneously obtained. In other words, by stacking the above-mentioned first metal layer, second metal layer, insulation layer, semiconductor layer and organic layer on each other, the supporting pads 320 are formed, as shown in FIG. 3.

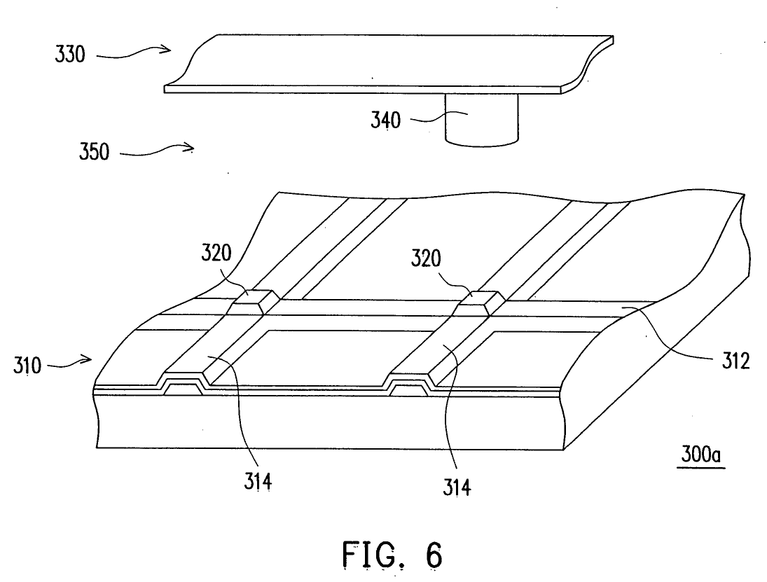

In another embodiment, the supporting pads 320 can be obtained by the original metal overlapping areas on the first substrate 310 or the original protrusion areas on the first substrate 310. FIG. 6 is a schematic tri-dimensional side view of an LCD panel provided by another embodiment of the present invention. Referring to FIG. 6, the LCD panel 300a includes a first substrate 310, at least one supporting pad 320, a second substrate 330, at least one spacer 340 and a liquid crystal layer 350. The LCD panel 300a is similar with the described LCD panel 300. Identical or similar components are labeled identically and related description is omitted. Especially, each of the scan lines 312 and each of the data lines 314 are cross-overlapped to form the supporting pad 320 spontaneously. Therefore, no additional steps are needed. As a result, the process of manufacturing the supporting pad 320 is simplified.

The present invention does not limit the method to form the supporting pads 320. No matter the supporting pads 320 are obtained by taking advantage of the metal overlapping areas or the original protrusion areas on the TFT array substrate, any method is without departing from the scope or spirit of the invention, as long as the essential requirement of the invention is met that the area of the top facet 322 of the supporting pads 320 is smaller than the area of the top facet 342 of the spacer 340 and the supporting pads 320 is pressed into the spacer 340.

Please Referring to FIG. 3, in an embodiment of the present invention, the second substrate 330 can be a color filter substrate, which has a glass substrate (not shown), a color filter layer (not shown) and a common electrode 332. In particular, during fabricating the color filter layer, the spacers 340 can be directly formed on the second substrate 330 by stacking the color filter layers, or by general photolithography process with photo resists.

In summary, the LCD panel of the present invention has the following advantages:

(1) The provided supporting pads are able to be effectively pressed into the spacers, which ensure the spacers and the supporting pads to support the first substrate and the second substrate very well.

(2) By means of the unique design of the spacers and the supporting pads, the margin of the ODF process is enhanced and further the bubbles and the mura defect occurred in the liquid crystal layer are reduced.

(3) Since the top facet area of the supporting pad is smaller than the top facet area of the spacer, the assembly deviation problem during assembling the LCD panel is avoided.

(4) By combining the spacers and the supporting pads together, the LCD panel of the present invention is capable of bearing a larger finger pressure.

(5) Since the bottom area of the spacer is larger than the top facet area thereof, the present invention is able to effectively disperse the press force, so as to prevent the common electrode under the spacer from being crashed.

(6) No extra process is required to form the supporting pads in the present invention, which contributes to lower the process cost of the LCD panel.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An LCD panel, comprising:
a first substrate;
at least a supporting pad, being disposed on the first substrate;
a second substrate, being disposed opposite to the first substrate;
at least a spacer, being disposed on the second substrate; and
a liquid crystal layer, being disposed between the first substrate and the second substrate;
wherein the top facet of the spacer contact with the top facet of the supporting pad, and the top facet area of the supporting pad is smaller than the top facet area of the spacer.

2. The LCD panel as recited in claim 1, wherein the top facet diameter of the supporting pad is ranged from 4 to 40 μm.

3. The LCD panel as recited in claim 1, wherein the top facet diameter of the spacer is ranged from 10 to 46 μm.

4. The LCD panel as recited in claim 1, wherein the shape of the supporting pad comprises at least one of square-section column shape, rectangular-section column shape, cylinder shape, ellipse-section column shape, regular polygon-section column shape and irregular polygon-section column shape.

5. The LCD panel as recited in claim 1, wherein the shape of the spacer comprises at least one of square-section column shape, rectangular-section column shape, cylinder shape, ellipse-section column shape, regular polygon-section column shape and irregular polygon-section column shape.

6. The LCD panel as recited in claim 1, wherein the bottom area of the spacer is larger than the top facet area thereof.

7. The LCD panel as recited in claim 1, wherein the hardness of the supporting pad is higher than the hardness of the spacer.

8. The LCD panel as recited in claim 1, wherein the material of the spacer comprises an elastic material.

9. The LCD panel as recited in claim 8, wherein the elastic material comprises resin.

10. The LCD panel as recited in claim 1, wherein the supporting pad is formed by stacking a plurality of film layers on the first substrate.

11. The LCD panel as recited in claim 10, wherein the material of the film layers comprises metal, dielectric material or organic material.

12. The LCD panel as recited in claim 1, wherein the first substrate comprises a TFT array substrate.

13. The LCD panel as recited in claim 12, wherein the TFT array substrate comprises:
a plurality of scan lines and a plurality of data lines;
a plurality of TFTs, being driven by the scan lines and the data lines; and
a plurality of pixel regions, being electrically connected to the TFTs.

14. The LCD panel as recited in claim 13, wherein each of the plurality of the scan lines and each of the plurality of the data lines are cross-overlapped to form the supporting pad.

15. The LCD panel as recited in claim 1, wherein the second substrate comprises a color filter substrate.
